(19) United States
(12) Patent Application Publication
(10) Pub. No.: US 2020/0183491 A1
(43) Pub. Date: Jun. 11, 2020

(54) AIRCRAFT COCKPIT AND METHOD OF DISPLAYING IN AN AIRCRAFT COCKPIT

(71) Applicant: Airbus Operations SAS, Toulouse (FR)

(72) Inventors: Javier MANJON SANCHEZ, TOULOUSE (FR); Cedric DESCHEEMAEKER, TOULOUSE (FR); Hélène DA COSTA GOMES, TOULOUSE (FR)

(21) Appl. No.: 16/691,841

(22) Filed: Nov. 22, 2019

(30) Foreign Application Priority Data
Dec. 5, 2018 (FR) 18 72346

(51) Int. Cl. G06F 3/01; G02B 27/01; B64D 43/00

(52) U.S. Cl. CPC G06F 3/013; G02B 2027/0178; B64D 43/00; G02B 27/0172

(57) ABSTRACT

The cockpit of an aircraft comprises a head-up display, a display computer configured to control the display of information on the head-up display and a system for measuring the position of the eyes of a pilot of the aircraft. The display computer is configured to receive from the measuring system the position of the pilot's eyes, when the pilot is located in the cockpit, position information on the pilot's eyes, compare the received position of the pilot's eyes with an acceptable volume for the position of the pilot's eyes; and if the received position of the pilot's eyes is not included within the acceptable volume, determining a direction in which the pilot would need to move his/her eyes in order to bring the position of the eyes back into the acceptable volume, and controlling the display of an indication on the head-up display, indicating the direction to the pilot.

### CROSS-REFERENCES TO RELATED APPLICATIONS

This application claims the benefit of the French patent application No. 1872346 filed on Dec. 5, 2018, the entire disclosures of which are incorporated herein by way of reference.

### FIELD OF THE INVENTION

The invention relates to the display of information for positioning assistance of a pilot in an aircraft cockpit.

### BACKGROUND OF THE INVENTION

The cockpit of an aircraft, in particular of a transport plane, comprises a seat adjustable in position so as to allow a pilot, or a co-pilot, to adjust his/her seat in order to see, in an appropriate manner, both the environment external to the aircraft, and the various human-machine interfaces installed in the cockpit (control buttons, handles, display screen, etc.). The document FR 2 902 757 A1 discloses a visual locator formed of spheres positioned in the cockpit in such a manner that, when the pilot (or the co-pilot) sees two aligned spheres, he/she is correctly positioned in the cockpit, in other words the position of his/her eyes corresponds to a predetermined reference point. This visual locator is generally fixed onto a central section of the windscreen of the cockpit, this section bounding two windows of the cockpit. These two windows are situated one in front of the pilot and the other in front of the co-pilot. In future, it may be envisaged for an aircraft to comprise a single window in the center of the cockpit, situated in front of both the pilot and the co-pilot. In such a case, the windscreen of the cockpit does not comprise a central section allowing the fixing of a visual locator such as the aforementioned. There consequently exists a need for an alternative solution to such a visual locator.

### SUMMARY OF THE INVENTION

An aim of the present invention is notably to provide a solution to this need. It relates to a cockpit of an aircraft comprising:
a head-up display;
a display computer configured for controlling the display of information on the head-up display; and
a system for measuring the position of the eyes of a pilot of the aircraft.

The cockpit is noteworthy in that the display computer is configured for:
receiving from the system for measuring the position of the eyes of a pilot of the aircraft, when a pilot is located in the cockpit of the aircraft, position information on the eyes of the pilot;
comparing the received position of the eyes of the pilot with an acceptable volume for the position of the eyes of the pilot; and
if the received position of the eyes of the pilot is not included within the acceptable volume:
determining a direction in which the pilot would need to move his/her eyes in order to bring the position of the eyes back into the acceptable volume; and
controlling the display of an indication on the head-up display, indicating the direction to the pilot.

Thus, when the position of the eyes of the pilot is outside of the acceptable volume, the head-up display displays an indication indicating to the pilot a direction in which he/she must move his/her eyes. The pilot can thus modify the position of his/her seat so as to move his/her eyes in this direction so as to bring them into the acceptable volume. For as long as the position of the eyes of the pilot is not included within the acceptable volume, an indication of the direction in which the pilot has to move his/her eyes remains displayed on the head-up display. When the position of the eyes of the pilot is included within the acceptable volume, the indication is no longer displayed (or another indication is displayed, in order to inform the pilot that the position of his/her eyes is included within the acceptable volume) and the pilot thus knows that the position of his/her eyes is satisfactory.

According to various embodiments which may be combined with one another:
the indication corresponds to a symbology, in particular to at least one arrow indicating the direction in which the pilot would have to move his/her eyes in order to bring the position of the eyes back into the acceptable volume;
the display computer is a computer for managing the head-up display;
the display computer is a computer connected to the computer for managing the head-up display;
the display computer is configured for inhibiting the display of the indication on the head-up display during flight phases predetermined as critical flight phases of the aircraft;
the display computer is configured for controlling the display of the indication on the head-up display:
according to a first display mode during flight phases predetermined as non-critical flight phases of the aircraft; and
according to a second display mode during flight phases predetermined as critical flight phases of the aircraft,
the display according to the second display mode being less intrusive for the pilot than the display according to the first display mode;
the cockpit furthermore comprises a motorized system for adjusting the position of a seat of the pilot and the display computer is configured for transmitting a command to the motorized system for adjusting the seat of the pilot, in such a manner as to bring the position of the eyes of the pilot into the acceptable volume.

The invention also relates to a method of displaying in a cockpit of an aircraft the cockpit comprising:
a head-up display;
a display computer configured for controlling the display of information on the head-up display; and
a system for measuring the position of the eyes of a pilot of the aircraft.

The method is noteworthy in that it comprises the following steps implemented by the display computer:
receive from the system for measuring the position of the eyes of a pilot of the aircraft, when a pilot is located in the cockpit of the aircraft, position information on the eyes of the pilot;
compare the received position of the eyes of the pilot with an acceptable volume for the position of the eyes of the pilot; and
if the received position of the eyes of the pilot is not included within the acceptable volume:
determine a direction in which the pilot would need to move his/her eyes in order to bring the position of the eyes back into the acceptable volume; and
control the display of an indication on the head-up display, indicating the direction to the pilot.

According to various embodiments that may be combined with one another:
the method comprises a step for acquiring information on the current flight phase of the aircraft and the step for controlling the display of the indication on the head-up display is inhibited if the information on the current flight phase of the aircraft corresponds to a flight phase predetermined as a critical flight phase of the aircraft;
the method comprises a step for acquiring information on the current flight phase of the aircraft and, at the step for controlling the display of the indication on the head-up display, a command is sent for displaying the indication on the head-up display:
according to a first display mode during flight phases predetermined as non-critical flight phases of the aircraft; and
according to a second display mode during flight phases predetermined as critical flight phases of the aircraft,
the display according to the second display mode being less intrusive for the pilot than the display according to the first display mode;
the cockpit furthermore comprising a motorized system for adjusting the position of a seat of the pilot, the method furthermore comprises a step for transmission, by the display computer, of a command to the motorized system for adjusting the seat of the pilot, in order to bring the position of the eyes of the pilot into the acceptable volume.

The invention also relates to an aircraft comprising a cockpit such as the aforementioned.

### BRIEF DESCRIPTION OF THE DRAWINGS

The invention will be better understood upon reading the description that follows and upon examining the appended figures.

FIG. 1 illustrates, in a simplified manner, an aircraft comprising a cockpit.

FIG. 2 illustrates schematically an aircraft cockpit according to one embodiment of the invention.

FIG. 3A illustrates a first example of a display on a head-up screen of the cockpit.

FIG. 3B illustrates a second example of a display on a head-up screen of the cockpit.

### DETAILED DESCRIPTION OF THE PREFERRED EMBODIMENTS

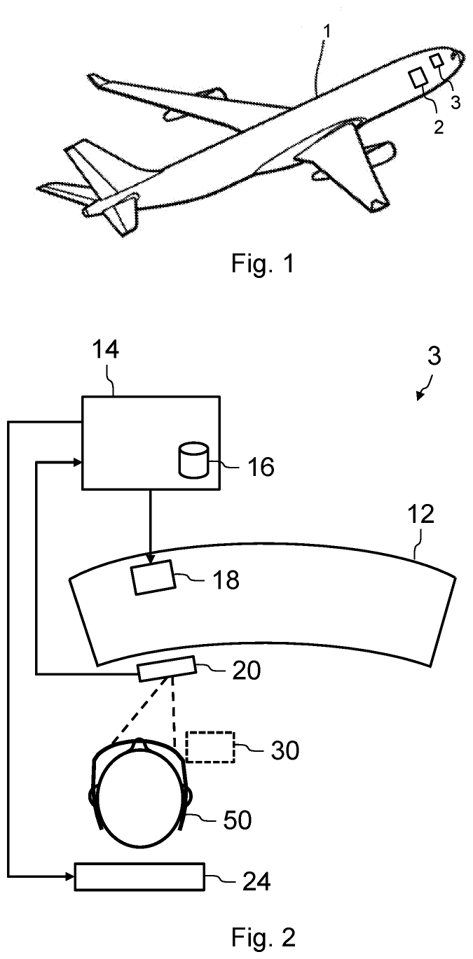

The aircraft 1 shown in FIG. 1 comprises a cockpit 3 in a front part of the aircraft. In the embodiment shown in FIG. 2, the cockpit 3 comprises a windscreen 12 and a head-up display 18. The head-up display 18 is placed between the windscreen 12 and a position of the head 50 of a pilot when the pilot is located in the cockpit for flying the aircraft. Thus, the pilot can see information displayed on the head-up display 18, superposed with the environment external to the aircraft visible through the windscreen. The cockpit 3 also comprises a system 20 for measuring the position of the eyes of the pilot. According to a first alternative, this system forms part of a system for detecting any incapacity of the pilot. According to a second alternative, this system is a system dedicated to the measurement of the position of the eyes of the pilot. The system 20 for measuring the position of the eyes of the pilot is connected at the output to a display computer 14 provided for controlling the display of information on the head-up display 18. The computer 14 comprises a memory or a database 16, or is connected to such a memory or database 16. The memory or the database 16 is configured so as to record information or a set of information corresponding to an acceptable volume 30 for the position of the eyes of the pilot. According to a first variant, the display computer 14 corresponds to a computer for managing the head-up display 18. According to a second variant, the display computer 14 is a specific computer connected to the computer for managing the head-up display 18. According to a third variant, the software functions implemented by the display computer 14 are implemented in a modular avionics computer connected to the computer for managing the head-up display 18. The display computer 14 is, for example, localized in an avionic rack 2 of the aircraft.

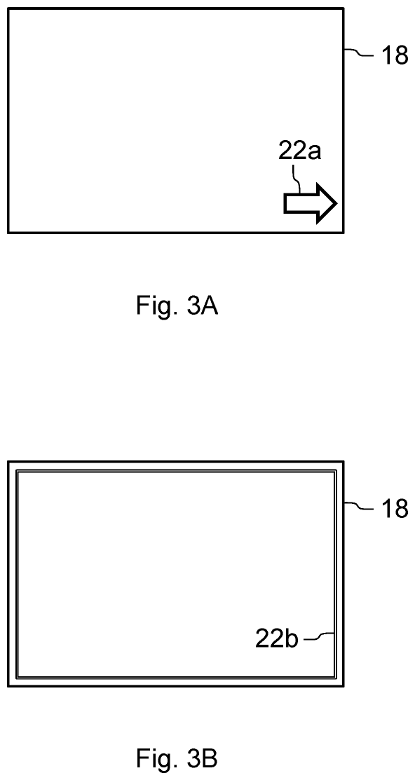

In operation, the system 20 for measuring the position of the eyes of the pilot measures a current position of the eyes of the pilot when the pilot is situated on his/her seat. This position of the eyes of the pilot corresponds, for example, to the position of the geometrical center of the two eyes of the pilot in a reference frame linked to the cockpit 3. The position of the eyes is a geometrical position which does not need to take the direction of the gaze of the pilot into account. The system 20 transmits the current position of the eyes of the pilot to the display computer 14 which receives it. The display computer 14 acquires, from the memory or from the database 16, information relating to the acceptable volume 30 for the position of the eyes of the pilot. The display computer 14 then compares the position of the eyes of the pilot with the acceptable volume 30. If the position of the eyes of the pilot is not included within the acceptable volume 30, the display computer 14 determines a direction in which the pilot would need to move his/her eyes in order to bring the position of the eyes back into the acceptable volume. In the example shown in FIG. 2, the acceptable volume 30 is situated on the right (seen from above) of the head of the pilot. Consequently, the pilot has to move his/her eyes to the right (by adjusting his/her seat in a suitable manner) in order to bring them into the acceptable volume 30. The display computer 14 then controls the display of an indication on the head-up display 18, this indication indicating the direction to the pilot in which he/she has to move his/her eyes. In particular, this indication may correspond to an arrow indicating the direction in which the pilot would need to move his/her eyes in order to bring their position into the acceptable volume 30. In the aforementioned example, this indication thus corresponds to an arrow 22a oriented to the right, as shown in FIG. 3A.

In one particular embodiment, the display computer 14 does not control the display of any indication to aid positioning of the pilot when the current position of the eyes of the pilot is included within the acceptable volume 30. Thus, for as long as an indication to aid positioning, for example an arrow, is displayed on the head-up display 18, the pilot can adjust his/her seat in such a manner as to move the position of his/her eyes in the direction corresponding to this indication. When no indication to aid positioning is displayed, the pilot then knows that his/her position is correct.

In another particular embodiment, the display computer 14 controls the display of a specific indication to aid positioning of the pilot when the current position of the eyes of the pilot is included within the acceptable volume 30. This specific indication corresponds, for example, to a frame 22b displayed around the periphery of the head-up display 18, as shown in FIG. 3B. Thus, for as long as an indication to aid positioning indicating a direction of movement of the eyes, for example an arrow, is displayed on the head-up display 18, the pilot can adjust his/her seat in such a manner as to move the position of his/her eyes in the direction corresponding to this indication. When the specific indication 22b is displayed, the pilot then knows that his/her position is correct.

In one embodiment, the display computer 14 is configured for receiving information on the current flight phase of the aircraft (transmitted, for example, by an avionics system of the aircraft). The display computer 14 then verifies whether the current flight phase corresponds to a flight phase predetermined as a critical flight phase of the aircraft. The flight phases predetermined as critical flight phases of the aircraft correspond for example to the take-off or to the landing of the aircraft. When the current flight phase corresponds to a critical flight phase of the aircraft, the display computer 14 inhibits the display of the indication 22a, 22b to aid the positioning of the pilot. This avoids the pilot being distracted with the display of the indication, in order for him/her to be able to fully concentrate on flying the aircraft.

In another embodiment, when the flight phase of the aircraft corresponds to a non-critical flight phase, the display computer 14 controls the display of the indication 22a, 22b on the head-up display 18 according to a first display mode. When the flight phase of the aircraft corresponds to a critical flight phase, the display computer 14 controls the display of the indication 22a, 22b on the head-up display 18 according to a second display mode. The first display mode and the second display mode are such that the display according to the second display mode is less intrusive for the pilot than the display according to the first display mode. This avoids the pilot being distracted with the display of the indication, in order for him/her to be able to fully concentrate on flying the aircraft during the critical flight phases. According to a first example, the first display mode corresponds to a display of amber or red color and the second display mode corresponds to a display of green color. According to a second example, the first display mode corresponds to a flashing display and the second display mode corresponds to a fixed display.

In one advantageous embodiment, the cockpit comprises a motorized system 24 for adjusting the seat of the pilot. The display computer 14 is configured for verifying whether it receives, after controlling the display of the indication 22a on the head-up display 18, a validation from the pilot via a human-machine interface of the cockpit. If it receives such a validation, the display computer transmits a command to the motorized system 24 for adjusting the seat, in order to bring the position of the eyes of the pilot into the acceptable volume 30. Preferably, the display computer 14 only transmits such a command to the motorized system for adjusting the seat if the current flight phase does not correspond to a critical flight phase of the aircraft. This command corresponds, for example, to a difference between the position of the eyes of the pilot and the center of the acceptable volume 30.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A cockpit of an aircraft comprising:
a head-up display;
a display computer configured for controlling a display of information on the head-up display; and
a system to measure a position of eyes of a pilot of the aircraft,
the display computer being configured to:
receive from the system to measure the position of the eyes of the pilot of the aircraft, when the pilot is located in the cockpit of the aircraft, information on the position of the eyes of the pilot;
compare the received position of the eyes of the pilot with an acceptable volume for the position of the eyes of the pilot; and
if the received position of the eyes of the pilot is not included within the acceptable volume:
determine a direction in which the pilot would need to move his/her eyes in order to bring the position of the eyes into the acceptable volume; and
control a display of an indication on the head-up display, indicating the direction to the pilot.

2. The cockpit according to claim 1, wherein the indication corresponds to a symbology indicating the direction in which the pilot would need to move his/her eyes in order to bring the position of the eyes into the acceptable volume.

3. The cockpit according to claim 2, wherein the symbology comprises at least one arrow.

4. The cockpit according to claim 1, wherein the display computer is a computer configured to manage the head-up display.

5. The cockpit according to claim 1, wherein the display computer is a computer connected to a computer configured to manage the head-up display.

6. The cockpit according to claim 1, wherein the display computer is configured for inhibiting the display of the indication on the head-up display during flight phases predetermined as critical flight phases of the aircraft.

7. The cockpit according to claim 1, wherein the display computer is configured to control the display of the indication on the head-up display:
according to a first display mode during flight phases predetermined as non-critical flight phases of the aircraft; and
according to a second display mode during flight phases predetermined as critical flight phases of the aircraft,
wherein the display according to the second display mode is less intrusive for the pilot than the display according to the first display mode.

8. The cockpit according to claim 1, further comprising a motorized system configured to adjust a position of a seat of the pilot and wherein the display computer is configured to transmit a command to the motorized system, in order to bring the position of the eyes of the pilot into the acceptable volume.

9. A method of displaying in a cockpit of an aircraft, the cockpit comprising:
a head-up display;
a display computer configured to control a display of information on the head-up display; and
a system configured to measure a position of eyes of a pilot of the aircraft,
wherein the method comprises the following steps implemented by the display computer:
receiving from the system configured to measure the position of the eyes of a pilot of the aircraft, when a pilot is located in the cockpit of the aircraft, position information on the eyes of the pilot;
comparing the received position of the eyes of the pilot with an acceptable volume for the position of the eyes of the pilot; and
if the received position of the eyes of the pilot is not included within the acceptable volume:
determining a direction in which the pilot would need to move his/her eyes in order to bring the position of the eyes into the acceptable volume; and
controlling a display of an indication on the head-up display, indicating the direction to the pilot.

10. The method according to claim 9, further comprising a step of acquiring information on a current flight phase of the aircraft, wherein the step of controlling the display of the indication on the head-up display is inhibited if the information on the current flight phase of the aircraft corresponds to a flight phase predetermined as a critical flight phase of the aircraft.

11. The method according to claim 9, further comprising a step of acquiring information on a current flight phase of the aircraft and, at the step of controlling the display of the indication on the head-up display, sending a command to display the indication on the head-up display:
according to a first display mode during flight phases predetermined as non-critical flight phases of the aircraft; and
according to a second display mode during flight phases predetermined as critical flight phases of the aircraft,
wherein the display according to the second display mode is less intrusive for the pilot than the display according to the first display mode.

12. The method according to claim 9, wherein the cockpit furthermore comprises a motorized system configured to adjust a position of a seat of the pilot, the method furthermore comprising:
transmitting, by the display computer, a command to the motorized system, to bring the position of the eyes of the pilot into the acceptable volume.

13. An aircraft comprising a cockpit according to claim 1.
